(19) United States
(12) Patent Application Publication
(10) Pub. No.: US 2004/0115419 A1
(43) Pub. Date: Jun. 17, 2004

(54) Hot air dried absorbent fibrous foams

(76) Inventors: Jian Qin, Appleton, WI (US); Xiaomin Zhang, Appleton, WI (US); Hoa La Wilhelm, Appleton, WI (US)

Correspondence Address: Pauley Petersen Kinne & Erickson, Suite 365, 2800 W. Higgins Road, Hoffman Estates, IL, 60195, US

(21) Appl. No.: 10/322,373

(22) Filed: Dec. 17, 2002

(51) Int. Cl. B32B 3/26; B32B 5/24

(52) U.S. Cl. 428/311.11; 428/317.9

(57) ABSTRACT

This invention relates to wet laid absorbent fibrous foams including water insoluble fibers, a binding agent, and a superabsorbent material in. The absorbent fibrous foams of this invention have controlled absorption rates and typically absorb about 60 percent of a foam centrifuge retention capacity of 0.9 percent by weight sodium chloride solution according to the centrifuge retention capacity test, in about 30 seconds or more and have a dry tensile strength of about 0.2 g/cm/gsm or more. The hot air dried absorbent fibrous foams of this invention have desirable wet and dry tensile strengths, according to the tensile strength test described herein. The hot air dried absorbent foams of this invention are produced by forming a slurry comprising water, a binding agent, and a water-insoluble fiber, adding a superabsorbent material having a gelation time of about 40 seconds or more to the slurry, removing an amount of the water from the slurry by hot air drying, and recovering an absorbent fibrous foam.

### FIELD OF INVENTION

This invention relates to wet laid absorbent composite materials having multifunctional absorbent properties. More specifically this invention relates to absorbent fibrous foams having increased tensile strengths and controlled absorption rates. This invention also relates to a hot air drying process for making the wet laid absorbent fibrous foam materials.

### BACKGROUND OF THE INVENTION

Various absorbent materials and structures are known in the art. Important characteristics of commercial absorbent materials and structures include fluid intake, fluid retention, and fluid distribution. Commercial absorbent materials and structures often exhibit at most two of these desired characteristics and are weak in the others. Nonwoven surge materials, for example, have excellent intake functionality but almost no fluid distribution and retention properties.

A typical disposable absorbent article generally includes a topsheet, a backsheet, and an absorbent core/composite between the topsheet and backsheet. In typical current commercial absorbent structures, layers of different materials, such as a surge layer and an absorbent core layer, are required to provide all the desired fluid handling characteristics. The result is usually a bulky absorbent article requiring many production steps and high cost. There is a need for absorbent materials having multifunctional absorbent properties such as desirable fluid intake, fluid retention, and fluid distribution characteristics.

Methods known in the field of papermaking of wet laying pulp fluff by forming a slurry of a solvent, such as water, and wood pulp fluff and removing the solvent by vacuum dewatering or high temperature drying processes typically result in high density, very stiff fibrous sheets. It is believed that when inter-capillary water molecules are removed from the fluff matrix by high temperature drying processes, the surface tension of water creates a pressure so high that the fluff fiber networks are completely collapsed to form a tightly packed fiber structure. There are many inter-fiber hydrogen bonds formed due to such a tight structure, resulting in a high density, high stiffness fibrous structure. Debonders and crimping processes are used in the paper industry to provide a more open and softer fluff sheet. Wet laid tissues do not generally include a superabsorbent material.

The use of water-swellable, water-insoluble superabsorbent materials in air laid fibrous matrix as an absorbent core is well known in the art. As an alternative to fibrous matrix absorbent cores containing superabsorbent materials, absorbent polymeric foams are also known. Absorbent polymer foams generally have lower absorbency rates and can have poor liquid distribution properties. This is typically due to physical characteristics of the foam structure, including discontinuous pore channels, a too large average cell size, unacceptably wide cell size distribution, and/or capillary diameters that vary widely and randomly.

There is a need for absorbent composite materials having an open and stable structure, a low density, and desired fluid handling properties. There is a need for an inexpensive, low production step process for forming such an absorbent composite material including superabsorbent materials.

### SUMMARY OF THE INVENTION

It has been discovered that hot air drying can be used to produce absorbent fibrous foam from a slurry including a solvent, fibers, a binding agent, and a superabsorbent material. The absorbent fibrous foams produced by hot air drying generally include different morphologies and properties than absorbent fibrous foams produced using previously known freeze-drying techniques. In one embodiment of this invention, the wet laid absorbent fibrous foam, referred to below as an absorbent fibrous foam, includes water insoluble fibers, a binding agent, and a superabsorbent material. The absorbent fibrous foam absorbs about 60 percent of an absorbent fibrous foam centrifuge retention capacity of 0.9 percent by weight sodium chloride solution according to the centrifuge retention capacity test described below, in about 30 seconds or more.

The hot air dried absorbent fibrous foams of this invention have high tensile strengths, both when dry and wet. In one embodiment of this invention, the absorbent fibrous foam includes water insoluble fibers, a binding agent, and a superabsorbent material. The absorbent fibrous foam has a tensile strength of about 0.2 grams/centimeter/grams per square meter or more, according to the tensile strength test described below.

In one embodiment of this invention, the hot air dried absorbent fibrous foams are produced by first forming a slurry comprising a solvent, such as water, a binding agent, and a water-insoluble fiber. An absorbent material, such as a superabsorbent material, having a gelation time of about 40 seconds or more is added to the slurry. An amount of the water, desirably substantially all of the water, from the slurry is removed by hot air drying and an absorbent fibrous foam is recovered. The absorbent fibrous foams of this invention can include up to about 30% by weight water based on the total dry weight of the absorbent fibrous foam, more specifically about 20% by weight water or less, more specifically about 10% by weight water or less, and more specifically about 5% by weight water or less.

Hot air drying processes of this invention can be used in combination with freeze-drying techniques to produce absorbent fibrous foams. In one embodiment of this invention, a slurry comprising a solvent, such as water, a binding agent, and a water-insoluble fiber is made. An absorbent material, such as a superabsorbent material, having a gelation time of about 40 seconds or more is added to the slurry. A first amount of the water less than all the water in the slurry, is removed by hot air drying. Freeze-drying is used to remove a second amount, more specifically substantially all, of the water remaining in the slurry, and an absorbent fibrous foam is then recovered.

In another embodiment of this invention, a slurry comprising a solvent, such as water, a binding agent, and a water-insoluble fiber is made. An absorbent material, such as a superabsorbent material, having a gelation time of about 40 seconds or more is added to the slurry. A first amount of the water is removed by freeze-drying before hot air drying is done. Hot air drying is then used to remove a second amount of water from the slurry, and an absorbent fibrous foam is then recovered. Desirably the first and second amounts of water equal substantially all the water in the slurry.

### BRIEF DESCRIPTION OF THE DRAWINGS

These and other objects and features of this invention will be better understood from the following detailed description taken in conjunction with the drawings, wherein:

FIG. 1 is an exploded perspective view of a diaper according to one embodiment of this invention.

FIG. 2 is an illustration of the equipment for determining gelation time of superabsorbent material.

FIG. 3 depicts bonded fibers of an absorbent fibrous foam according to one embodiment of this invention.

FIG. 4A shows a hot air dried absorbent fibrous foam according to one embodiment of this invention.

FIG. 4B shows a general freeze-dried absorbent fibrous foam known in the art.

FIG. 4C shows an absorbent fibrous foam according to one embodiment of this invention made by partially hot air drying and subsequent freeze drying.

FIG. 4D shows an absorbent fibrous foam according to one embodiment of this invention made by partially freeze drying and subsequent hot air drying.

FIG. 5 is an illustration of equipment for determining the Absorbency Under Load (AUL) value of a superabsorbent material.

FIG. 6 is a cross-sectional view of the porous plate taken along line 6-6 of FIG. 5.

### DEFINITIONS

Within the context of this specification, each term or phrase below will include the following meaning or meanings.

“Hot air drying” refers to a method of using hot air to remove a solvent from a slurry by evaporation which results in a solid material including other components from the slurry. Hot air drying can be accomplished, without limitation, by use of ovens or blowing hot air from heaters over the material to be dried. Useful hot air drying times and temperatures vary depending on the solvent and other slurry materials as well as production costs and timeframes.

“Freeze-drying” refers to a method of freezing a solvent in a slurry, removing the solvent, and obtaining a solid material including other components from the slurry. Freeze-drying uses sublimation to remove the frozen solvent. Freeze-drying apparatuses are known in the art.

Removing “substantially all” of a solvent, such as water, from a slurry by hot air drying processes, freeze drying processes, or combinations of these processes according to this invention refers to removal of about 70% by weight or more of the solvent based on the total weight of the original slurry, specifically about 80% by weight or more of the solvent based on the total weight of the original slurry, more specifically about 90% by weight or more of the solvent based on the total weight of the original slurry, and more specifically about 95% by weight or more of the solvent based on the total weight of the original slurry.

“Foam” refers to two-phase gas-solid systems that have a supporting solid lattice of cell walls that are continuous throughout the structure. The foams can have polymeric cell walls or fibrous cell walls such as taught in this invention. The gas, typically air, phase in a foam is usually distributed in void pockets often called cells. “Fibrous foam” refers to foams having a plurality of fibers as a supporting lattice matrix. “Open-cell” refers to foam materials, both polymeric and fibrous having substantial void space in the form of cells defined by a plurality of mutually connected, three dimensionally branched webs of polymeric material. The cells typically have openings to permit fluid communication from one cell to another. In other words, the individual cells of the foam are not completely isolated from each other by the polymeric and/or fibrous materials of the cell walls. The cells in such substantially open-celled foam structures have intercellular openings which are large enough to permit fluid transfer from one cell to another within the foam structure. For purposes of this invention, a foam material is “open-celled” if 80 percent or more of the cells in the foam structure that are about 1 micron size or more are in fluid communication with at least one adjacent cell.

“Capillary size” refers to size of the open cells in the fibrous composites of this invention. The capillaries, or interconnected open cells, are the passage ways through which fluids are taken into the absorbent fibrous composites.

“Low-density” refers to a density of about 0.1 gram per cubic centimeter or less.

“Hydrophilic” describes fibers or the surfaces of fibers, or other components, which are wettable by the aqueous liquids in contact with the fibers. The degree of wetting of the materials can, in turn, be described in terms of the contact angles and the surface tensions of the liquids and materials involved. Equipment and techniques suitable for measuring the wettability of particular fiber materials or blends of fiber materials or other components can be provided by a Cahn SFA-222 Surface Force Analyzer System, or a substantially equivalent system. When measured with this system, fibers or other components having contact angles about 90° or less are designated “wettable” or hydrophilic, while fibers having contact angles greater than 90° are designated “nonwettable” or hydrophobic.

“Polymer” includes, but is not limited to, homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to isotactic, syndiotactic and atactic symmetries.

“Superabsorbent material” refers to a water-swellable, water-insoluble organic or inorganic material capable, under the most favorable conditions, of absorbing about 10 times its weight or more, more specifically about 20 times its weight or more, in an aqueous solution containing 0.9 percent by weight sodium chloride. Superabsorbent material can comprise a form including particles, fibers, nonwovens, coforms, printings, coatings, other structural forms, and combinations thereof. “Water-swellable, water-insoluble” refers to the ability of a material to swell to a equilibrium volume in excess water but not dissolve into the water. The water-swellable, water-insoluble material generally retains its original identity or physical structure, but in a highly expanded state upon the absorption of water.

“Absorbency Under Load (AUL)” refers to the measure of the liquid retention capacity of a material under mechanical load. It is determined by a test, described below, which measures the amount, in grams, of a 0.9 percent by weight aqueous sodium chloride solution a gram of material can absorb in 1 hour under an applied load or restraining pressure of about 0.3 pound per square inch (20,700 dynes per square centimeter).

“Absorbency Under Zero Load (AUZL)” refers to the result of a test, described below for Absorbency Under Load, which measures the amount in grams of an aqueous 0.9 percent by weight sodium chloride solution that a gram of material can absorb in 1 hour under negligible applied load (about 0.01 pound per square inch (690 dynes per square centimeter)).

“Water-soluble” refers to materials which substantially dissolve in excess water to form a solution, thereby losing its initial form and becoming essentially molecularly dispersed throughout the water solution. As a general rule, a water-soluble material will be free from a substantial degree of crosslinking, as crosslinking tends to render a material water insoluble. A material that is “water-insoluble” is one that is not water soluble according to this definition.

“Solvent” refers to a substance, particularly in liquid form, that is capable of dissolving a polymer used herein to form a substantially uniformly dispersed mixture at the molecular level.

The term “absorbent article” includes without limitation diapers, training pants, swim wear, absorbent underpants, baby wipes, adult incontinence products, feminine hygiene products, medical garments, underpads, bandages, absorbent drapes, cosmetic products, and medical wipes, as well as industrial work wear garments.

These terms may be defined with additional language in the remaining portions of the specification.

### DETAILED DESCRIPTION OF THE PRESENTLY PREFERRED EMBODIMENTS

This invention relates to hot air dried absorbent fibrous foams containing fibers, superabsorbent materials, and binding agents. The absorbent fibrous foams exhibit multifunctional fluid absorbent properties such as controlled absorption rate, desirable fluid distribution and retention, and excellent tensile strength. The absorbent fibrous foams of this invention are useful in absorbent articles such as diapers, training pants, swim wear, adult incontinence articles, feminine care products, and medical absorbent products.

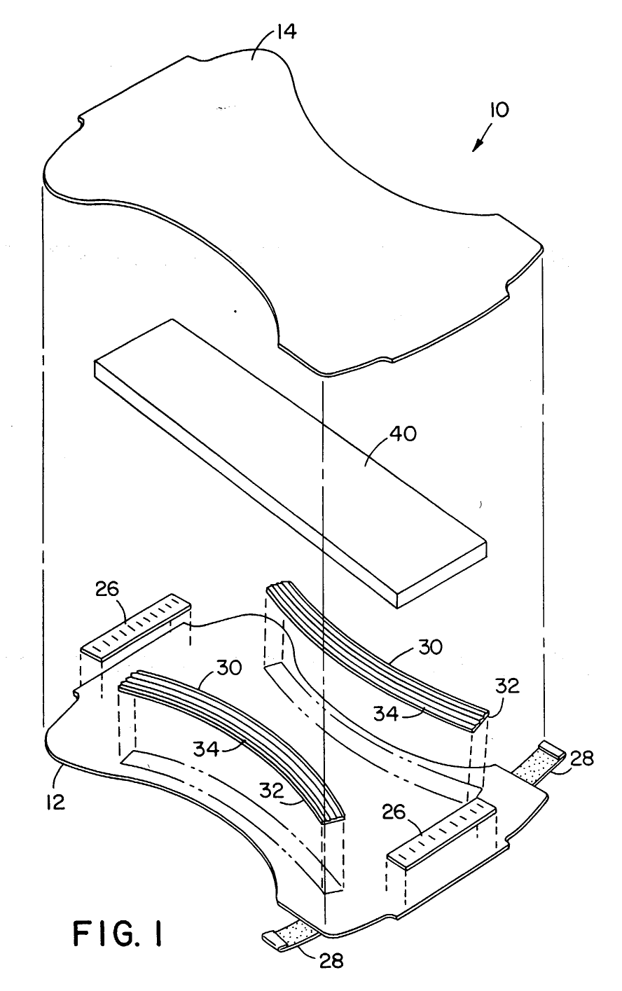

FIG. 1 illustrates an exploded perspective view of a disposable diaper. Referring to FIG. 1, disposable diaper 10 includes outer cover 12, body-side liner 14, and absorbent core 40 located between body-side liner 14 and outer cover 12. Absorbent core 40 can include any of the fibrous absorbent foams according to this invention. The absorbent core 40 can include the absorbent fibrous foams of this invention combined with other composite materials known in the art, such as freeze dried absorbent fibrous foams. The differences in morphology and absorbent properties between the absorbent fibrous foams of this invention and other composite materials known in the art allow can provide an absorbent core having regions of different core materials and therefore regions of differing absorbency, strength, and thickness. Body-side liner 14 and outer cover 12 are constructed of conventional non-absorbent materials. By “non-absorbent” it is meant that these materials have an absorptive capacity not exceeding about 5 grams of 0.9 percent aqueous sodium chloride solution per gram of material.

Body-side liner 14 is constructed from highly liquid pervious materials. This layer functions to transfer liquid from the wearer to absorbent core 40. Suitable liquid pervious materials include porous woven materials, porous nonwoven materials, films with apertures, open-celled foams, and batting. Examples include, without limitation, any flexible porous sheets of polyolefin fibers, such as polypropylene, polyethylene or polyester fibers; webs of spunbonded polypropylene, polyethylene or polyester fibers; webs of rayon fibers; bonded carded webs of synthetic or natural fibers or combinations thereof. The various layers of disposable diaper 10 have dimensions which vary depending on the size and shape of the wearer.

The material comprising the outer cover 12 should be breathable to water vapor. Generally the outer cover 12 will have a moisture vapor transmission rate (MVTR) of about 300 grams/m²-24 hours or more, typically about 1000 grams/m²-24 hours or more, more typically about 3000 grams/m²-24 hours or more, measured using INDA Test Method IST-70.4-99, herein incorporated by reference. Attached to the outer cover 12 are waist elastics 26, fastening tapes 28 and leg elastics 30. The leg elastics 30 typically have a carrier sheet 32 and individual elastic strands 34. The diaper of FIG. 1 is a general representation of one basic diaper embodiment. Various modifications can be made to the designs and materials of diaper parts.

In one embodiment of this invention, the method of making the hot air dried absorbent foams of this invention includes forming a slurry of a solvent, a binding agent, and a water insoluble fiber material. A water-swellable, water-insoluble superabsorbent material is then added to the slurry. The slurry can be poured into a pan or a mold. The solvent is then removed from the slurry through evaporation by hot air drying. The resulting foam is an absorbent fibrous foam including a water-swellable, water-insoluble superabsorbent material in combination with, and particularly intermixed with, a water insoluble fiber. The solvent can be any fluid, such as water, alcohol, and acetone, and is described below as water. Hot air drying can be done in an oven. The hot air drying of this invention is desirably done at temperatures of about 60° C. to about 250° C., specifically about 100° C. to about 200° C., and more specifically about 100° C. to about 150° C., for a time from about 1 minute to about 100 hours, specifically about 10 minutes to about 20 hours, and more specifically from about 30 minutes to about 10 hours.

Hot air drying according to this invention provides absorbent fibrous foams having different morphologies and fluid handling properties than other absorbent composite materials, such as air-laid composites from the absorbent cores of commercial diapers or freeze-dried foams. For instance, hot air dried absorbent fibrous foams of this invention typically have slower absorption rates than a freeze-dried fibrous foam made from equivalent materials. In one embodiment of this invention, the absorbent fibrous foam absorbs about 60 percent of a foam centrifuge retention capacity of 0.9 percent by weight sodium chloride solution, according to the centrifuge retention capacity test described below, in about 30 seconds or more, specifically about 40 seconds or more, and more specifically about 50 seconds or more.

In addition, the hot air drying methods of this invention provide absorbent fibrous foams having increased wet and dry strength. The hot air dried fibrous foams of one embodiment of this invention have a dry tensile strength of about 0.2 grams/centimeter/grams per square meter (g/cm/gsm) or more according to the tensile strength test described below, more specifically about 0.5 g/cm/gsm or more, and more specifically about 1.0 g/cm/gsm or more. The hot air dried fibrous foams of one embodiment of this invention have a wet tensile strength of about 0.05 grams/centimeter/grams per square meter (g/cm/gsm) or more according to the tensile strength test described below, more specifically about 0.1 g/cm/gsm or more, and more specifically about 3.0 g/cm/gsm or more. The hot air dried fibrous foams of this invention also demonstrate increased binder efficiency. “Binder efficiency” refers to the tensile strength of the fibrous foam relative to the amount of binding agent in the fibrous foam, and is defined by the tensile strength of the foam, either wet or dry, divided by the percent by weight of binding agent in the fibrous foam. The hot air dried foams of this invention have a dry binder efficiency of about 15 or more, more specifically about 20 or more, and more specifically about 30 or more. The hot air dried foams of this invention have a wet binder efficiency of about 2.5 or more, more specifically about 5 or more, and more specifically about 10 or more.

The water-swellable, water-insoluble superabsorbent material of one embodiment of this invention is present in the absorbent fibrous foam in a weight amount of about 10 percent by weight or more, specifically about 10 percent to about 80 percent by weight, more specifically about 20 percent to about 60 percent by weight, and more specifically about 30 percent to about 60 percent by weight. The water-insoluble fiber is present in the absorbent fibrous foam in a weight amount of about 20 percent to about 90 percent by weight, specifically about 20 percent to about 80 percent by weight, and more specifically about 40 percent to about 70 percent by weight. The binding agent is present in the absorbent fibrous foam in a weight amount of about 20 percent by weight or less, specifically about 1 percent to about 10 percent by weight, and more specifically about 2 percent to about 5 percent by weight.

According to one embodiment of this invention, the hot air dried absorbent fibrous foam is a fluff based foam, referring to the fibrous material matrix of the absorbent fibrous foam structure. Water-insoluble fibers suitable for this invention include both natural fibers, including without limitation wood pulp and cotton linter, and synthetic fibers, including without limitation thermoplastic fibers, such as polyethylene fibers, polypropylene fibers, and poly(ethylene terephthalate) fibers, elastic fibers such as polyurethane fibers, and other synthetic fibers including, without limitation, polyvinyl alcohol, polyvinyl chloride, polyacrylonitrile, and combinations thereof. Hydrophilic fibers are preferred due to their wettability characteristics. Hydrophobic fibers can be used and may be treated with surfactants or other effective treatment to alter surface chemistry to increase wettability. Additional fibers not disclosed herein may also be useful for the absorbent fibrous foams of this invention.

Fiber size can affect the capillary structure of the final absorbent fibrous foam. Generally, the larger the fiber size the larger the capillary size, and as the capillary size gets larger the wicking efficiency may decrease. Oppositely, smaller fiber size provides smaller capillary size, but liquid flux may decrease. The diameters of the fibers of this invention are about 1 micron to about 100 microns, more specifically about 1 micron to about 50 microns, and more specifically about 10 microns to about 30 microns. Mixing fibers with different diameters in the absorbent fibrous foam structure to create a desired capillary size gradient can achieve a balance in both wicking efficiency and liquid flux Water-swellable, water-insoluble superabsorbent materials suitable for this invention include any crosslinked anionic or cationic polymers, as well as mixtures thereof. Anionic polymer examples include without limitation, sodium-polyacrylate, carboxymethyl cellulose (CMC), carboxymethyl polysaccharides including starch, chitin, and other gums, polyaspartic acid salt, maleic anhydride-isobutylene copolymer, and copolymers and admixtures of these polymers. Cationic examples include without limitation, chitosan salts, polyquarternary ammonium salts, polyvinyl amines, and copolymers and admixtures of these polymers. Physical form of the superabsorbent materials can be particulate, fibrous, nonwoven, coform, printed, coated, combinations of these, or other forms.

Current commercial superabsorbent materials are generally characterized by rapid fluid absorbency. Adding these fast-absorbing materials to the water-based slurry used in the method of this invention to produce hot air dried absorbent foams results in the superabsorbent materials absorbing the water from the slurry. This absorption of water from the slurry by the superabsorbent material can result in undesired decrease in slurry flowability. When the slurry is used to form sheets of absorbent fibrous foam, the slurry is poured into a mold and a drastic decrease in slurry flowability results in a non-uniform sheet of absorbent fibrous foam. A “uniform” sheet of absorbent fibrous foam refers to a sheet having substantially the same thickness and amount of superabsorbent material throughout the absorbent fibrous foam. Uniformity of the absorbent fibrous foam sheet can depend on the flowability of the slurry in that flowable slurry will disperse uniformly in the absorbent fibrous foam production mold. A “non-uniform” absorbent fibrous foam sheet may have a varying thickness and/or component (i.e., fibers, superabsorbent, etc.) concentration throughout the foam sheet. A non-uniform sheet of absorbent fibrous foam usually contains many large cracks and voids which are detrimental to fluid distribution properties as well as dry and wet integrity. In order to retain flowability of the aqueous slurry a slow absorption rate superabsorbent material can be used, or the absorption rate of a fast absorption rate superabsorbent material may be slowed using external means. For example, suitable mixing conditions have been identified which slow down superabsorbent absorption rates.

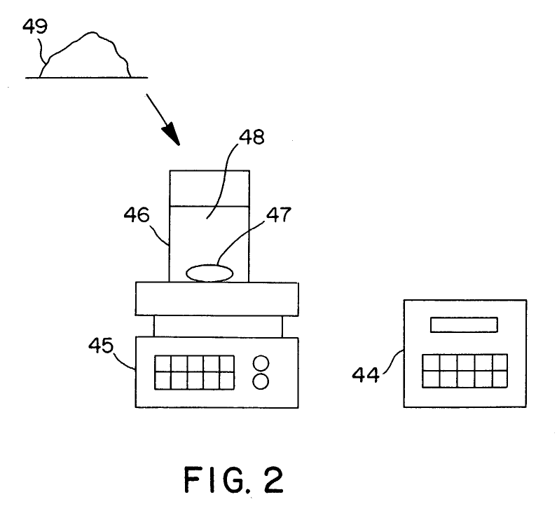

A parameter defined as gelation time (GT) is useful in determining if a superabsorbent material or mixing condition is suitable for this invention. FIG. 2 shows an apparatus usable in determining gelation time of a superabsorbent material. Beaker 46 is filled with distilled water 48 and placed on stir plate 45. Enough superabsorbent material 49, and any additional agent if necessary, to absorb substantially all of water 48 is added to beaker 46. The slurry is stirred by magnetic stir bar 47 until the superabsorbent material absorbs the water leaving a gelatinous material inside the beaker. Timer 44 records the time necessary for superabsorbent material 49 to absorb the water 48.

The method of producing an absorbent fibrous foam according to one embodiment of this invention includes forming a slurry including water, a binding agent, and a water-insoluble fiber. An absorbent material, such as a superabsorbent material, having a gelation time of about 40 seconds or more is added to the slurry. Substantially all the water is removed from the slurry by hot air drying and an absorbent fibrous foam is recovered. Suitable superabsorbent materials for this invention may have a gelation time of about 40 seconds or more, specifically about 50 seconds or more, more specifically about 60 seconds or more, and more specifically about 80 seconds or more.

Slowing the fluid absorption rate of a superabsorbent material can be achieved through many ways. Suitable ways include without limitation: (1) hydrophobilization of the superabsorbent material surface by coating the superabsorbent material with a hydrophobic agent such as a hydrocarbon oil or silicon oil, synthesizing superabsorbent beads in a hydrophobic medium such as benzene, or spinning superabsorbent fibers into a hydrophobic environment such as hot dry air; (2) reducing surface area of the superabsorbent material by using larger dimension superabsorbent particles or fibers; (3) using the nonionic, non-neutralized acid form of the superabsorbent material, which has a lower absorption rate, and then neutralizing to obtain desired superabsorbent salt while in the slurry solution; (4) encapsulating the superabsorbent materials in a slow liquid-penetrating film of slow absorbent or substantial nonabsorbent chemical such as polyvinyl alcohol which will break as the superabsorbent material begins to swell; (5) using a non-neutralized ion exchanging superabsorbent that exhibits a slow absorption rate due to additional ion exchanging step, but is neutralized in the process of making the absorbent composite so that the neutralized superabsorbent material in the absorbent fibrous foam will exhibit a fast absorption rate, with such superabsorbent materials usually include a mixture of acidic and basic absorbent polymers; and (6) decreasing the solvent temperature.

Suitable mixing conditions that slow down fast absorption rate superabsorbent material have also been discovered. Decreasing the solution temperature or using a soluble, high molecular weight ionic polymer binding agent, such as carboxymethyl cellulose, in the slurry with the water-swellable, water-insoluble superabsorbent material slows the absorption rate of the superabsorbent material. The amount of high molecular weight ionic polymer has been found to be inversely proportional to absorption rate of the superabsorbent material. The change in viscosity of the slurry with the addition of the high molecular weight ionic polymer causes the slowed absorption rate. Therefore, when a proper amount of such water-soluble high molecular weight ionic polymer is used in the slurry prior to the addition of the superabsorbent material, absorption rate of the superabsorbent material becomes almost irrelevant to the formation of uniform absorbent fibrous foam. Suitable high molecular weight ionic polymers have a molecular weight of about 10,000 to about 10,000,000, specifically about 50,000 to about 1,000,000, and more specifically about 100,000 to about 1,000,000.

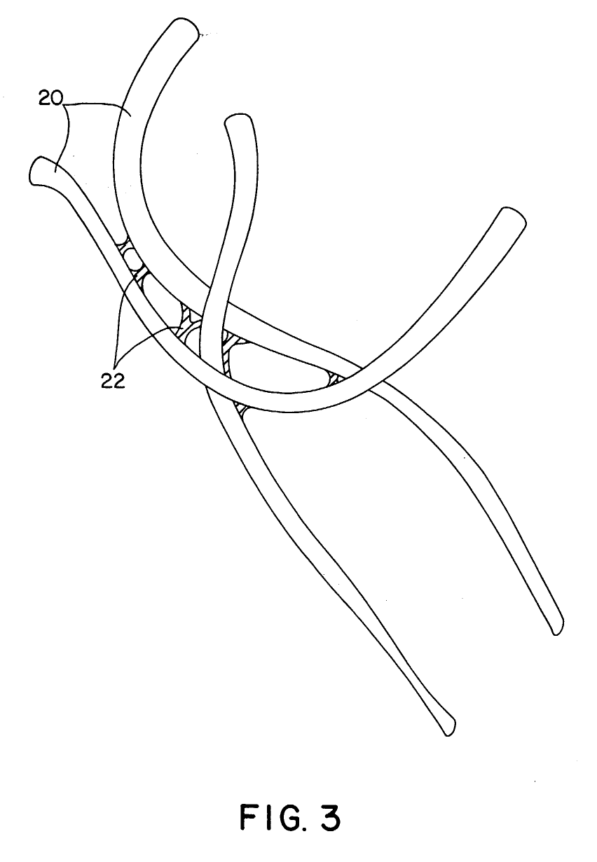

Small amounts of organic solvents that are soluble in water but are not solvents to superabsorbent materials, such as methanol, ethanol, isopropanol, ethylene glycol, propylene glycol, ether, acetone, and/or mixtures of these, can be used in water to slow down absorption rate of superabsorbent materials. However, the solvents can also reduce the swelling capability of the superabsorbent material. It is important to limit the amount of such solvents to an extent that is enough to slow down absorption rate but not too much to significantly reduce swelling Binding agents provide strength to the absorbent fibrous foam both in the dry state and the wet state. Binding agents are typically water-soluble or dispersible in the slurry and water-insoluble in the absorbent fibrous foam after hot air drying and/or heat curing. Binding agents bind the water-insoluble fibers and the superabsorbent materials together. As shown in FIG. 3, fibers 20 are held together in the absorbent fibrous foam structure by binding agent 22. The binding agent may be water-swellable or not water-swellable. For use in absorbent articles the binding agent is desirably water-swellable. Desirable binding agent polymers are hydrophilic and substantially water-insoluble in the absorbent fibrous foam, providing desired wet strength of the fibrous composite.

For swellable binding agents, high molecular weight ionic polymers such as sodium-polyacrylate, carboxymethyl cellulose, and chitosan salt are useful in that they provide strength and absorbency to the hot air dried foam. Other swellable binding agents include isobutylene-maleic anhydride copolymers, polyvinyl amines, polyquarternary ammoniums, polyvinyl alcohols, hydroxypropyl celluloses, polyethylene oxides, polypropylene oxides, polyethylene glycols, modified polysaccharides, proteins, and combinations thereof. Non-swellable, lower molecular weight binding agents include kymene, latex, and other adhesives. Other non-swellable binding agents include any wet strength resins used in the paper making industries and any type of adhesive material. If an adhesive is used it is preferred that the adhesive is hydrophilic.

A crosslinking agent is often needed to insolubilize a water-soluble binding agent after formation of the absorbent fibrous foam structure. Crosslinking agents are typically water-soluble. Suitable crosslinking agents include organic compounds comprising at least two functional groups capable of reacting with at least one of carboxyl, carboxylic acid, amino, and/or hydroxyl groups. Examples of this type of crosslinking agents include without limitation, diamines, polyamines, diols, polyols, polycarboxylic acids, and polyoxides. Another suitable crosslinking agent is a metal ion with more than two positive charges, including without limitation, Al³⁺, Fe³⁺, Ce³⁺, Ce⁴⁺, Ti⁴⁺, Zr⁴⁺, and Cr³⁺. When cationic polymer binding agents are used, polyanionic substances are suitable crosslinking agents. Polyanionic substances include without limitation, sodium-polyacrylate, carboxymethyl cellulose, and polymers including the phosphate anion PO₄³⁻.

Hot air dried absorbent fibrous foams of this invention, as-prepared, typically have a density of about 0.1 gram/cubic centimeter (g/cc) or less. “As-prepared” refers to the hot-air dried foams produced according to this invention without additional densification by additional processes. With a density of about 0.1 g/cc or less, any material is likely to have suitable fluid intake properties due to a relatively high volume of free space (i.e., voids and capillaries). Other fibrous materials are known to have a density below 0.1 g/cc, such as low density nonwoven surge materials and low density current commercial absorbent cores. However, such surge materials and absorbent cores generally lose the beneficial intake properties when they are densified to a density of about 0.2 g/cc or more.

The hot air dried absorbent fibrous foams of this invention have excellent fluid intake properties. Hot air dried absorbent fibrous foams of this invention generally have a relatively low density. The hot air dried absorbent fibrous foams can be densified to a density much higher than its “as-prepared” density, such as from about 0.3 g/cc to about 0.5 g/cc, by various physical compression means known in the art. The densified hot air dried absorbent fibrous foams are beneficial in decreasing the overall thickness of absorbent articles. Densifying hot air dried absorbent fibrous foam results in forming temporary inter-capillary bonds that hold composite at the higher density. The densified absorbent fibrous foam maintains essentially the same beneficial fluid intake properties (i.e., intake rate and capacity) as it had as a non-densified absorbent composite because a fluid insult releases the temporary inter-capillary bonds formed during the densification process. The permanent intercapillary bonds formed by the binding agent gives the absorbent fibrous foam an ability to return to the low density structure before densification, also referred to as a “memory” of the pre-densified structure, when other restrictions (for example, the temporary inter-capillary bonds) are removed. The breaking of the temporary inter-capillary bonds causes the densified absorbent composite to quickly expand back to at least substantially both the as-prepared shape and density in a matter of seconds. Such quick expansion allows the hot air dried absorbent composite to regain the fluid intake functionality it had at the initial, as-prepared lower density. Unless densified to a degree that permanent inter-capillary bonds formed by the binding agent are destroyed, the densification does not have a significant negative impact on fluid intake property of the absorbent fibrous foam.

Hot air dried absorbent fibrous foams of this invention, as prepared, typically have a density of about 0.1 gram foam/cubic centimeter (g/cc) or less, specifically from about 0.01 g/cc to about 0.1 g/cc, more specifically about 0.01 g/cc to about 0.075 g/cc, and more specifically about 0.01 g/cc to about 0.05 g/cc. Hot air dried absorbent fibrous foams of this invention can be densified to obtain a density of about 0.2 g/cc or more, specifically about 0.2 g/cc to about 0.5 g/cc, and more specifically about 0.3 g/cc to about 0.5 g/cc. Densification of the hot air dried absorbent fibrous foams also enhances overall softness and flexibility.

In one embodiment of this invention, the hot air drying process of this invention can be combined with a freeze-drying process, such as described in co-pending U.S. patent application Ser. No. 10/017,465, to produce absorbent fibrous foams having different morphologies and properties than absorbent fibrous foams made by only hot air drying or freeze drying. While not intending to be bound by theory, it is believed that the superabsorbent material in absorbent fibrous foam, such as in this invention, plays a vital role not only in fluid retention, but also in regards to the porous, three-dimensional structure of the absorbent fibrous foam. Swelled superabsorbent dries at a much slower rate than the fiber and binder within the slurry, resulting in two-stage drying. Thus, if the fiber and binder matrix dry first, the matrix network becomes stabilized before the swelled superabsorbent deswells. The presence of the swelled superabsorbent material prevents the collapse of the fibrous network that typically occurs in paper-making processes. When the superabsorbent deswells, the volume that the swelled superabsorbent particles occupied produces, at least in part, the pore structure within the absorbent fibrous foam.

The concept of two-stage drying allows for the combination of absorbent fibrous foam drying techniques, referred to below as “combination drying,” such as hot air drying of this invention and freeze-drying, to produce absorbent fibrous foams having new, different multifunctional fluid absorbent properties. In one embodiment of this invention, an absorbent fibrous foam is produced by forming a slurry comprising water, a binding agent, and a water-insoluble fiber and adding an absorbent material having a gelation time of about 40 seconds or more to the slurry. A first amount of water that is less than then all the water in the slurry, and desirably all the water not absorbed by the superabsorbent material, is removed from the slurry by hot air drying. The remaining water, and particularly the water absorbed in the superabsorbent material, in the slurry is removed by freeze-drying the slurry. Desirably, the amount of water removed by both hot air drying and freeze-drying together equals all of the water from the slurry, and an absorbent fibrous foam is recovered. However, the absorbent fibrous foams of this invention can include up to about 30 percent by weight water based on the total dry weight of the absorbent fibrous foam. In one embodiment the amount of water removed by hot air drying is about 10 percent by weight or more, more specifically about 20 percent by weight or more, and more specifically about 30 percent by weight or more, of the original amount of water in the slurry.

In another embodiment of this invention, freeze-drying is done before hot air drying to remove a first amount of water, and a second amount of water is removed by hot air drying. The first and second amounts of water removed by freeze-drying and hot air drying, respectively, together equal substantially all of the water from the slurry, and an absorbent fibrous foam is recovered. In one embodiment, the first amount of the water removed by freeze-drying is about 10 percent by weight or more of the water originally in the slurry and the second amount of the water removed by hot air drying is about 90 percent by weight or less of the water originally in the slurry. More specifically, the first amount of the water removed by freeze-drying is about 20 percent by weight or more of the water originally in the slurry and the second amount of the water removed by hot air drying is about 80 percent by weight or less of the water originally in the slurry. More specifically, the first amount of the water removed by freeze-drying is about 30 percent by weight or more of the water originally in the slurry and the second amount of the water removed by hot air drying is about 70 percent by weight or less of the water originally in the slurry.

While in the slurry, the superabsorbent materials will absorb some water and swell. Hot air drying removes the water from the superabsorbent material and the deswelled superabsorbent material appears very similar to the dry non-swollen superabsorbent material. Freeze-drying, however, removes water from the superabsorbent material and allows the superabsorbent material to maintain the at least partially swollen state. Freeze-dried superabsorbent materials are porous, have high volume, and have increased absorption rates. Differences in absorption rate will be enhanced specially for menses or other high viscous fluids. A similar difference occurs in the morphology of the binding agent. Hot air drying allows the binding agent to become concentrated in the junctures between the fibers. The result is increased tensile strength and more efficient use of the binding agent. Freeze-drying has a similar effect on the binding agent as the superabsorbent material. Freeze-dried binding agent is not as concentrated at the fiber junctures and therefore does not provide the tensile strength obtained in hot air dried absorbent fibrous foams made with the same overall concentration of binding agent. It has been discovered that by using the principles of two stage drying, for example partially hot air drying followed by freeze-drying the same slurry, the desirable properties of both hot air drying and freeze drying can be obtained in one absorbent fibrous foam.

Freeze-drying techniques suitable for this invention include techniques described in co-pending U.S. patent application Ser. No. 10/017,465, to Qin et al., entitled “Absorbent Materials Having Improved Absorbent Properties,” herein incorporated by reference. For freeze-drying, the slurry temperature will be lowered to below the freezing point of the solvent used. When water is used as the slurry solvent, the temperature may be about 0° C. to about −50° C., specifically about −5° C. to about −50° C., more specifically about −10° C. to about −40° C., and more specifically about −10° C. to about −30° C. The selection of temperature is also dependent on the nature and concentration of the slurry. If the temperature selection is too close to the freezing point of the polymer slurry solution the frozen slurry may not have enough strength and may deform under vacuum removal of the solvent. If the temperature drops too far below the solvent freezing point the solvent molecules may form crystals which generally causes substantial cracks in the foam and reduces mechanical properties of the recovered foams.

During the freeze-drying process, the water molecules are first frozen at a temperature below the freezing point so that the slurry becomes an ice. After freezing the slurry, a high vacuum is applied on the frozen slurry. The vacuum is so high that it results in sublimation of water molecules from a solid state directly to a vapor state. Water vapor from the sublimation is collected by a condenser of a freeze dryer which is operated at a temperature of about −70° C. Freeze-drying is typically a slower process than hot air drying. Two parameters can be adjusted to control the freeze drying rate: freeze drying temperature and vacuum. The freeze-drying temperature can be about −60° C. to about 0° C., temperatures at which a solution or slurry can still be maintained in solid state. The lower the freeze-drying temperature, the slower the drying rate is, and vice versa. In general, fast drying rate causes a significant degree of shrinkage of absorbent foam due to high internal stress and lack of relaxation time. A lower slurry or solution concentration also causes a high degree of dimension reduction. High vacuum results in a fast drying rate. A high quality vacuum pump and a powerful condenser capable of reaching very low temperature (e.g., about −70° C. or less) are typically needed to achieve high vacuum. Using a condenser capable of reaching a low temperature helps ensure the capture of all moisture during sublimation of the frozen solution or slurry and thus achieves high vacuum.

High vacuum can also be achieved by lowering the freeze-drying temperature. A lower drying temperature slows down the rate of sublimation, thus reducing the rate of moisture generation. High vacuum can be achieved by varying additional factors including without limitation, the concentration of a solution, consistency of a slurry, type of solvent, thickness of frozen solution/slurry sheet, batch load of solution or slurry, material ratio of absorbent to nonabsorbent (i.e., superabsorbent material to fibers), uniformity of a slurry, and combinations thereof.

While freezing the slurry it is important to control the cooling rate of the slurry from room temperature (about 23° C.) to the freeze-drying temperature. The cooling rate should not exceed a critical cooling rate. “Critical cooling rate” refers to the cooling rate at which, or any rate greater, the slurry, as well as the final absorbent foam, begins to form visible cracks or visible non-uniformity. Critical cooling rate can vary depending upon the freezing point of the solvent used, concentration of slurry, use of a two solvent slurry, crystallizability of the solvent, ratio of insoluble fibers to superabsorbent material, and ratio of fibers to binding agent. A cooling rate slower than the critical cooling rate is preferred and generally results in a much more uniform pore structure and a softer, more flexible absorbent foam, due to the elimination of substantial cracks caused by uneven crystallization of solvent molecules. The cooling rate for an aqueous slurry having a weight ratio of insoluble fibers to soluble polymer of about 1 to about 9 or less or a weight ratio of water-swellable superabsorbent material to water-soluble polymer of about 1 to about 9 or less, should be about 0.01° C. to about 10° C. per minute, specifically about 0.05° C. to about 3° C. per minute, and more specifically about 0.1° C. to about 1° C. per minute.

Removal of the frozen solvent is preferably done by vacuum sublimation. Vacuum suitable for this invention is dependent on the volatility of solvent used. Higher vacuum can increase the rate of sublimation and lower vacuum applies a lower pressure on the frozen slurry that can result in less damage and a higher mechanical strength of the resulting foam. Vacuum conditions are typically about 500 millitorrs or less, more typically about 300 millitorrs or less, more typically about 200 millitorrs or less, and more typically about 100 millitorrs or less. In general, good vacuum can be achieved by either a good quality vacuum pump or a lower condenser temperature which captures more water vapor. Because sublimation is endothermic, the temperature of the frozen slurry is reduced as water is sublimated under vacuum. This means that the frozen slurry will be even colder and therefore it becomes more difficult to release water molecules. In order to compensate such energy loss, the freeze-dryer should be equipped with a heater which provides just enough heat to compensate the energy loss to maintain temperature at a predetermined level.

As described above, combinations of hot air drying and freeze-drying techniques have been discovered to produce absorbent fibrous foams having different morphologies and properties than either hot air drying and freeze-drying alone. Freeze-dried fibrous foams have porous and large superabsorbent materials due to the sublimation of absorbed water from the superabsorbent materials. Freeze-dried superabsorbent materials retain a swollen shape, due to water absorption, after removal of the water, resulting in an increase of the absorption rate of the foam. However, freeze-drying often results in a low efficiency of the binding agent, thereby requiring a greater amount of binding agent in order to achieve the same integrity as a hot air dried foam of this invention, as the binding agent in a freeze-dried foam is generally dispersed along the fibers and not localized at the fiber junctions. “Fiber junctions” refers to the points where two or more fibers are bonded together, and/or bonded to superabsorbent material particles, by the binding agent or crosslinked superabsorbent material precursor. Hot air dried absorbent fibrous foams typically have opposite properties from freeze-dried absorbent fibrous foams. Hot air drying results in the evaporation of the water from the superabsorbent materials. Thus the superabsorbent material deswells to about the preswollen size. In addition, the evaporation of the water results in the binding agent, or superabsorbent precursor, to be more concentrated at the fiber junctions. It is believed that the water near the fiber junctions is the last amount of water to evaporate. So the binding agent will collect and therefore be more concentrated at the fiber junctions. Thus hot air dried absorbent fibrous foams of this invention have slower absorption rates due at least in part to the size and surface area of the superabsorbent material, and strong, effective inter-fiber bonds due to the concentration of binding agent at the fiber junctions.

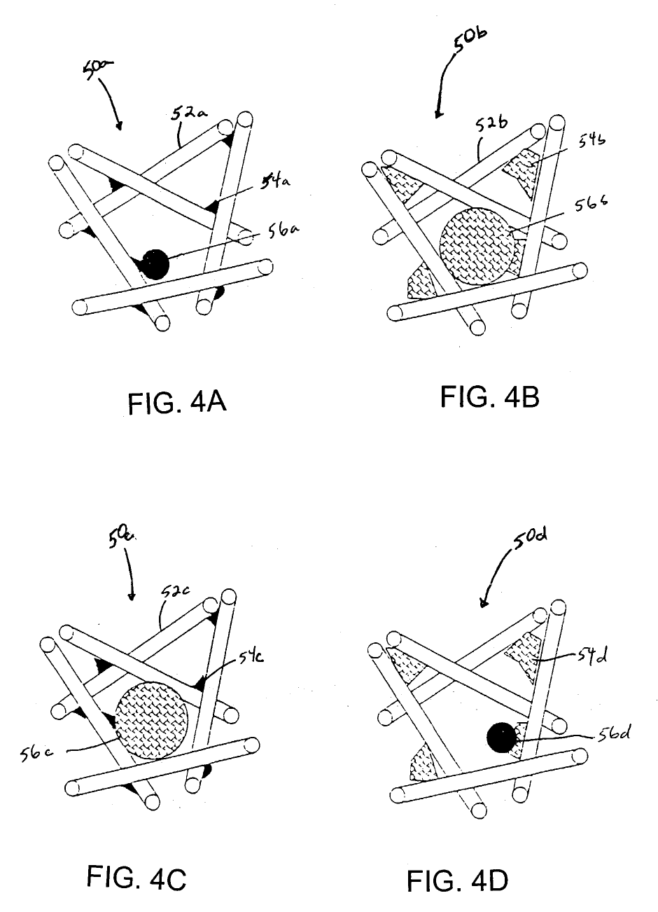

FIGS. 4A-4D represent four absorbent fibrous foams as made by various processes discussed herein. FIG. 4A represents a hot air dried foam 50a according to one embodiment of this invention. The hot air dried absorbent fibrous foam 50a includes a matrix of fibers 52a bonded together by a binding agent 54a. The binding agent 54a is concentrated at the fiber junctions of the matrix of fibers 52a. The smaller, more concentrated collection of binding agent 54a at each of the fiber junctions provides increased strength and integrity. A superabsorbent material particle 56a, also referred to herein as a superabsorbent particle, is located within the matrix of the fibers 52a. The superabsorbent material particle 56a is bonded to the matrix of the fibers 52a by the binding agent 54a. The superabsorbent material particle 56a is shown as being in a deswelled form, due to the evaporation of any absorbed water as described above.

FIG. 4B represents a typical absorbent fibrous foam obtained by a freeze drying process (with no hot air drying). The freeze dried fibrous foam 50b includes a matrix of fibers 52b bonded together by a binding agent 54b. The binding agent 54b is less concentrated within the matrix of the fibers 52b than the binding agent 54a in the hot air dried fibrous foam 50a. The less concentrated, larger collections of the binding agent 54b within the fiber 52b matrix does not have the binding strength and integrity of the binding agent 54a of hot air dried fibrous foam 50a. A superabsorbent material particle 56b is located within the matrix of the fibers 52b. The superabsorbent material particle 56b is bonded to the matrix of the fibers 52b by the binding agent 54b. The superabsorbent material particle 56b is shown as being in a swelled form yet containing little or no absorbed fluid. The freeze-drying of the superabsorbent material particle removes at least substantially all the absorbed fluid but does not return the superabsorbent material particle 56b to the original, deswelled form. The large, porous superabsorbent material particle 56b more readily absorbs fluids than a deswelled similar superabsorbent material particle, thereby providing increased fluid intake rates.

FIG. 4C represents an absorbent fibrous foam 50c of one embodiment of this invention, according to a combination drying method involving first hot air drying to remove a first amount of water from the slurry followed by freeze-drying to remove a second amount of water from the slurry. The absorbent fibrous foam 50c includes a matrix of fibers 52c bonded together by a binding agent 54c. As the slurry water not absorbed by the superabsorbent material evaporates first, hot air drying to remove the amount of water not absorbed by the superabsorbent material provides the more concentrated binding agent 54c. The binding agent 54c is concentrated within the matrix of the fibers 52c at the fiber junctions. The smaller, more concentrated collections of the binding agent 54c within the fiber 52c matrix provide increased strength and fibrous foam wet and dry integrity. A superabsorbent material particle 56c is located within the matrix of the fibers 52c. The superabsorbent material particle 56c is also bonded to the matrix of the fibers 52c by the binding agent 54c. The superabsorbent material particle 56c is shown as being in a swelled form, yet containing little or no absorbed fluid. By freeze-drying the slurry after the first amount of water was removed by hot air drying, to remove any water absorbed by the superabsorbent material particle 56c, the superabsorbent material particle 56c retains a porous, at least partially swollen form. Thus by combination drying by first removing water from the slurry by hot air drying, and subsequently removing a second amount from the superabsorbent material by freeze-drying, the resulting absorbent fibrous foam 50c has increased inter-fiber bond strength for increased integrity as well as superabsorbent materials with increased absorption rates.

FIG. 4D represents an absorbent fibrous foam 50d produced using combination drying by first freeze-drying and subsequently hot air drying. The result is an absorbent fibrous foam 50d having generally opposite characteristics from the absorbent fibrous foam 50c. By first freeze-drying the slurry the water is removed from within the matrix of the fibers 52d first. Thus the binding agent 54d is less concentrated at the fiber junctions by the matrix of the fibers 52d. By subsequently hot air drying to remove the water absorbed in the superabsorbent material particle 56d, the superabsorbent material particle 56d returns to the smaller, less porous deswelled state. While hot air drying followed by freeze drying according to this invention typically produces absorbent fibrous foams with fast absorption rates and increased strength and integrity, freeze drying followed by hot air drying typically results in slower absorption rates as well as less strength and integrity. Therefore, through combination drying according to this invention, absorbent fibrous foams having various forms and properties can be obtained.

Centrifuge Retention Capacity Test

As used herein, the centrifugal retention capacity (CRC) is a measure of the absorbent capacity of a superabsorbent material or fiber after being subjected to centrifugation under controlled conditions. In the case of hot air dried absorbent foam, the CRC can be measured by placing 0.500±0.01 grams of the sample material to be tested (moisture content of less than 5 weight percent) into a water-permeable bag which will contain the sample while allowing the test solution (0.9 percent by weight sodium chloride solution) to be freely absorbed by the sample. A heat-sealable tea bag material (grade 542, commercially available from Kimberly-Clark Corporation, Neenah, Wis.) works well for most applications. The bag is formed by folding a 7 inch by 3 inch (17.78 centimeter by 7.62 centimeter) sample of the bag material in half and heat sealing two of the open edges to form a 3.5 inch by 3 inch (8.89 centimeter by 7.62 centimeter) rectangular pouch. The heat seals should be about 0.25 inch (0.635 centimeter) inside the edge of the material. After the sample is placed in the pouch, the remaining open edge of the pouch is also heat-sealed. Empty bags are also made to be tested with the sample bags as controls. Three sample bags are tested for each absorbent material.

The sealed bags are placed between two Teflon coated fiberglass screens having 0.25 inch (0.635 centimeter) openings (Taconic Plastics, Inc., Petersburg, N.Y.) and submerged in a pan of 0.9 percent by weight sodium chloride solution at about 23° C., making sure that the screens are held down until the bags are completely wetted. After wetting, the samples remain in the solution for varied amount of time, at which time they are removed from the solution and are immediately placed into the basket of a suitable centrifuge capable of subjecting the samples to a force equivalent to 350 times the acceleration of gravity. (A suitable centrifuge is a Heraeus Instruments Labofuge 400, having a water collection basket, digital rotations per minute (rpm) gauge, and machined drainage basket adapted to hold and drawing the samples. The samples must be placed in opposing positions within the centrifuge to balance the basket when spinning. The bags are centrifuged at a target of 180° rotations per minute, but within the range of 1700-1900 rotations per minute, for 3 minutes (target force of 350 times the acceleration due to gravity). The bags are removed and weighed, with the empty bags (controls) being weighed first, followed by the bags containing the absorbent material. The amount of fluid absorbed and retained by the absorbent material, taking into account the fluid retained by the bag material alone, is the centrifugal retention capacity (CRC) of the absorbent material at that specific time, expressed as grams of fluid per gram of material. This calculation is done by the following equation:

$$C R C = \frac{( {W}_{s} - {W}_{e} - {W}_{d} )}{{W}_{d}}$$

where “CRC” is the centrifugal retention capacity of the sample (grams/gram), “Wₛ” is the after centrifuged mass of the teabag and the sample (grams), “Wₑ” is the average after centrifuged mass of the empty teabag (grams), and “W_{d}” is the dry mass of the sample (grams). The CRC measurements for each of three replicate are averaged to provide the CRC value of the material.

### Tensile Strength Test

The Tensile Strength Test uses a testing apparatus, such as an Instrom Model 4443 Universal Testing System, available from Instrom Corporation, Canton, Mass. Samples are mounted between two grips, 3 inches (7.62 centimeters) apart, of the testing apparatus. The apparatus is run according to the manual and pulls the sample in opposite directions at a rate of 25 millimeters per minute with increasing force until the sample breaks. The amount of force required to break the sample divided by the sample width and basis weight is recorded as the tensile strength. The size of the sample to be tested (when dry) is 5.08 centimeters by 12.7 centimeters and the samples are densified to 0.2 grams/cubic centimeter before testing. Densification can be done using a Carver press or other means known in the art. The Tensile Strength Test can be used to measure both wet and dry tensile strengths. For testing dry tensile strength the sample is tested without any additional manipulation. For testing wet tensile strength, the sample is mounted between the grips and 10 grams of 0.9 weight percent sodium chloride solution is added by pipette into the sample, added uniformly all over the sample. After 30 seconds the wetted sample is tested by the apparatus. The tensile strength is defined by the amount of force to break the sample divided by the width and sample basis weight.

### Softness Test

The Softness value of a material is determined by a test which is modeled after the ASTM D4032-82 Circular Bend Procedure. This modified test is used for the purposes of the present invention and is, hereinafter, simply referred to as the “Circular Bend Procedure.” The Circular Bend Procedure is a simultaneous multi-directional deformation of a material in which one face of a material becomes concave and the other face becomes convex. The Circular Bend Procedure gives a force value which relates to the stiffness of the material, simultaneously averaging stiffness in all directions, and is herein as being inversely related to the softness of the material.

The apparatus necessary for the Circular Bend Procedure is a modified Circular Bend Stiffness Tester, having the following parts: a smooth-polished steel plate platform which is 102.0 millimeters (length) by 102.0 millimeters (width) by 6.35 millimeters (depth) having a 18.75 millimeter diameter orifice. The lap edge of the orifice should be at a 45 degree angle to a depth of 4.75 millimeters. A plunger having the following dimensions is used: overall length of 72.2 millimeters, a diameter of 6.25 millimeters, a ball nose having a radius of 2.97 millimeters and a needle-point extending 0.88 millimeters from the ball nose with a 0.33 millimeter base diameter and a point having a radius of less than 0.5 millimeters. The plunger is mounted concentrically with the orifice having equal clearance on all sides. The needle-point is used merely to prevent lateral movement of a sample during testing. The bottom of the plunger should be set well above the top of the orifice plate. From this position, the downward stroke of the ball nose is to the exact bottom of the plate orifice.

An inverted compression load cell having a load range of from about 0.0 to about 2000.0 grams was used as a force measurement gauge. The compression tester used was an Instron Model No. 1122 inverted compression load cell, available from Instron Engineering Corporation of Canton, Mass.

After calibrating the load cell, the gage length for displacement of the plunger was set to 25.4 millimeter. To carry out the test, an absorbent foam sample was cut into a 38.1 by 38.1 millimeter square specimen using a die cutter. The sample was placed onto the test platform and the plunger was lowered down on the specimen for a 25.4 millimeter gage length at a crosshead speed of 500 millimeter/minute. During the movement of the plunger, the sample is deflected downward into the 18.75 millimeter hole by the plunger and the force exerted by the compression tester to deflect the sample during the 25.4 millimeter gage length displacement of the plunger is measured by the load cell and recorded. The force measured by the load cell divided by the basis weight of the sample is reported in units of grams force/grams per square meter of specimen (g/gsm). This value is used as the softness value to obtain a quantitative measure of the softness of the sample. The higher the softness value (in g/gsm) is, the more stiff and, thus, the less soft the specimen.

### Absorbency Under Load (AUL) Test

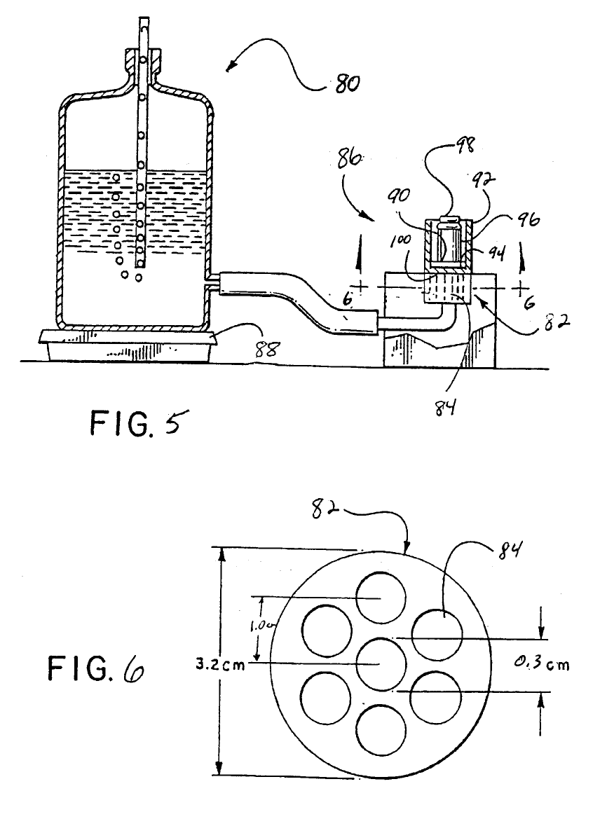

The Absorbency Under Load (AUL) test is a measure of the ability of a material to absorb a liquid while the superabsorbent material is under a restraining load. The test may best be understood by reference to FIGS. 5 and 6. Referring to FIG. 5, a demand absorbency tester (DAT) 80 is used, which is similar to a GATS (gravimetric absorbency test system), available from M/K Systems, Danners, Mass., as well as a system described by Lichstein in pages 129-142 of the INDA Technological Symposium Proceedings, March 1974.

A porous plate 82 is used having ports 84 confined within the 2.5 centimeters diameter covered, in use, by the absorbency under load apparatus 86. FIG. 6 shows a cross-sectional view of porous plate 82. The porous plate 82 has a diameter of 3.2 centimeters with 7 ports (holes) 84 each with diameter of 0.30 centimeters. The porous plate 82 has one hole 84 in the center and the holes are spaced such that the distance from the center of one hole to another adjacent to it is 1.0 centimeter. An electrobalance 88 is used to measure the flow of the test fluid (an aqueous solution containing 0.9% by weight sodium chloride) into the superabsorbent material 90.

The AUL apparatus 86 used to contain the sample material may be made from 1 inch (2.54 centimeters), inside diameter, thermoplastic tubing 92 machined-out slightly to be sure of concentricity. A U.S. standard #100 mesh (0.149 millimeter openings) stainless steel wire cloth 94 is adhesively attached to the bottom of tubing 92. Alternatively, the steel wire cloth 94 may be heated in a flame until red hot, after which the tubing 92 is held onto the cloth until cooled. Care should be taken to maintain a flat, smooth bottom and not distort the inside of the tubing 92. A 4.4 gram piston 96 may be made from 1 inch (2.54 centimeters) solid material (e.g., Plexiglas) and machined to closely fit, without binding, in the tubing 92. A 317 gram weight 98 is used to provide 62,000 dynes per square centimeter (about 0.9 pounds per square inch (psi)) restraining load on the superabsorbent material. For the purpose of the present invention, the pressure applied during the AUL test is 0.9 psi.

When the sample 90 is particulate, the desired amount of sample 90 is weighed onto weigh paper and placed on the wire cloth 94 at the bottom of the tubing 92. The tubing 92 is shaken to level the sample material on the wire cloth 94. Care is taken to be sure no sample material is clinging to the wall of the tubing 92. When the sample 90 is non-particulate, such as a fibrous foam, the sample is first cut by a 1 inch (2.54 centimeter) diameter circular sample cutter. The desired amount of sample 90 having multiple layers is weighed and pushed onto the bottom of tubing 92. The piston 96 and weight 98 are carefully placed on the sample material to be tested. The test is initiated by placing a 3 centimeter diameter glass filter paper 100 (Whatman filter paper Grade GF/A, available from Whatman International Ltd., Maidstone, England) onto the plate 82 (the paper is sized to be larger than the internal diameter and smaller than the outside diameter of the tubing 92) to ensure good contact, while eliminating evaporation over the ports 84 of the demand absorbency tester 80 and then allowing saturation to occur. The device is started by placing the apparatus 86 on the glass filter paper 100 and allowing saturation to occur. The amount of fluid picked up is monitored as a function of time either directly by hand, with a strip chart recorder, or directly into a data acquisition or personal computer system.

The amount of fluid pick-up measured after 60 minutes divided by the sample weight is the AUL value, which is reported in grams of test liquid absorbed per gram of superabsorbent material as determined before starting the test procedure. A check can be made to ensure the accuracy of the test. The apparatus 86 can be weighed before and after the test with a difference in weight equaling the fluid pick-up.

### EXAMPLE 1

Several commercial superabsorbent materials (SAM) were measured to determine their gelation time as described above. The commercial superabsorbent materials tested were DRYTECH® 2035 and FAVORS® 880. DRYTECH® 2035 is a crosslinked partially neutralized sodium polyacrylate, commercially available from Dow Chemical Company of Midland, Mich., having a degree of neutralization around 70 percent. FAVOR® 880 is a crosslinked partially neutralized sodium polyacrylate, commercially available from Stockhausen Inc. of Greensboro, N.C., having a degree of neutralization around 70 percent.

In addition, a polyacrylic acid superabsorbent material was also prepared for testing. The polyacrylic acid superabsorbent material was made by adding 24 kilogram of distilled water, 6 kilogram of acrylic acid, 10 grams of potassium persulfate (K₂S₂O₈), and 24 grams of N,N′-methylenebisacrylamide, all available from Aldrich Chemical Company, into a 10 gallon jacketed reactor equipped with an agitator and mixed at room temperature to form a completely dissolved solution. The reactor was then heated to 60° C. while running continuously for at least four hours. The resulting polyacrylic acid gel was cut into less than 1 inch cubes and dried in a ventilated oven at 60° C. for at least two days (48 hours). The completely dried polyacrylic acid polymer was ground into particulate by a commercial grinder (Model: C.W. Brabender Granu-Grinder) and sieved using a Sweco Separator (60.96 centimeter Model), to obtain polyacrylic acid polymer in a size range of 150 to 850 microns. The polyacrylic acid polymers had an Absorbency Under Zero Load (AUZL) value of about 7 grams liquid per gram polymer and an AUL value (load of 0.3 pounds per square inch (20,700 dynes per square centimeter)) of about 5 grams liquid per gram polymer. When the polyacrylic acid gel is mixed with sodium bicarbonate, NaHCO₃, powder at a ratio of about 55 weight percent to 45 weight percent, the mixture exhibits an AUZL of 32 grams liquid per gram mixture, and an AUL value of about 18 grams liquid per gram mixture.

To test the gelation time of the above superabsorbent materials, different amounts, as reported in Table 1, of CMC-7H, a carboxymethyl cellulose, available from Hercules Inc, were pre-dissolved as a binding agent into some beakers containing distilled water at 23° C. One superabsorbent material, FAVOR® 880, was also tested at additional water temperatures of 2° C., 42° C., and 63° C. An amount, also reported in Table 1, of each of the above superabsorbent materials was placed into the respective beaker and mixed. As described above, FIG. 2 shows a diagram of the apparatus which was used to measure gelation time of the superabsorbent materials.

To perform the test, 50 grams of distilled water were added into a 100 milliliter Pyrex glass beaker. If a binding agent is needed for the test, add the agent into the water and make sure it is completely dissolved before a superabsorbent material is added into the beaker. The beaker is on the top of a magnetic stirrer (DATAPLATE® Digital Hot Plate/Stirrer, PMC-731, PMC Industries, Inc.) and the water mixture was stirred by a magnetic stir bar (2.54 centimeters long by 0.95 centimeter diameter) at a speed of about 600 rotations per minute. The superabsorbent material was added into the beaker and a timer, available from Sper Scientific, Model 810026, was immediately started to record gelation time. Gelation time is the time when the superabsorbent material absorbs almost all the water, i.e., when the water mixture stops rotating within the beaker and looks like a whole piece of gel. The gelation time of each superabsorbent material was then measured and recorded. Table 1 summarizes the parameters and results of gelation time testing. Superabsorbent materials having a gelation time of greater than 40 seconds are typically able to make uniform absorbent fibrous foams and are useful in embodiments of this invention.

TABLE 1

| | SAM | Binding | | Water | |
|---|---|---|---|---|---|
| | weight | Agent | Water | Temp. | Gelation |
| SAM | (g) | CMC (g) | Amount (g) | (° C.) | Time (s) |
| Drytech 2035 | 2 | 0 | 50 | 23 | 39 |
| Favor 880 | 2 | 0 | 50 | 23 | 31 |
| Favor 880 | 1.98 | 0.02 | 50 | 23 | 34 |
| Favor 880 | 1.96 | 0.04 | 50 | 23 | 36 |
| Favor 880 | 1.94 | 0.06 | 50 | 23 | 53 |
| Favor 880 | 1.90 | 0.10 | 50 | 23 | 87 |
| Favor 880 | 1.80 | 0.20 | 50 | 23 | 204 |
| Polyacrylic | 2 | 0 | 50 | 23 | 375 |
| acid/NaHCO₃ | | | | | |
| Favor 880 | 2 | 0 | 50 | 2 | 130 |
| Favor 880 | 2 | 0 | 50 | 42 | 13 |
| Favor 880 | 2 | 0 | 50 | 63 | 9 |

### EXAMPLE 2

Each of the superabsorbent materials of Table 1 was then made into eight hot air dried absorbent fibrous foam samples, Samples 1-8, by the following procedure. Samples 1-8 were made to visually test uniformity and demonstrate the effect of superabsorbent material gelation time on the absorbent fibrous foam. After the slurry for each of Samples 1-8 was poured into its respective pan, the slurry was visually inspected for uniformity. A uniform foam sheet would appear relatively smooth and planar and have relatively few material conglomerates in the pan. A non-uniform sheet will typically have material conglomerates, due to the rapid absorption of slurry solvent by the superabsorbent material, resulting in a relatively lumpy sheet with inconsistent material concentrations throughout the sheet.

For making each of Samples 1-8, 1000 grams of distilled water and 20 grams of eucalyptus wood pulp fluff were added into a one gallon HOBART® mixer (Model N50), manufactured by Hobart Canada, Ontario, Canada. The fluff was mixed with the water by the stirrer of the mixer at a relatively slow speed (setting 1). 1.25 grams of carboxymethyl cellulose, available from Aqualon Company, Wilmington, Del., designated as Cellulose Gum CMC-7H, was used as a binding agent and slowly added to the stirring slurry. After about 15 minutes of stirring, 10 grams of the respective superabsorbent material (SAM), as described in Table 2, having a particle size ranging from about 300 microns to 600 microns, was added to the slurry while the stirrer of the mixer is mixing at a relatively fast speed (setting 2). The mixing is continued for about 30 seconds and the slurry was poured into a stainless steel pan with a size of 25.4 centimeter x×50.8 centimeter×2.54 centimeter. The slurries containing a fast superabsorbent material with a gelation time of less than 40 seconds, were not able to form a uniform sheet in the pan. The slow superabsorbent material slurries, as well as the fast superabsorbent material slurries containing enough binding agent to raise the gelation time over 40 seconds (Samples 5 and 6), did create uniform sheets in the pans. The pans were then placed into a Baxter oven at 80° C. for 15 hours. The resulting absorbent fibrous foams were then removed from the pans and heated at 130° C. for 2 hours to insolubilize the binding agent. Table 2 summarizes the components and results for Samples 1-8.

TABLE 2

| | | SAM | Water | Fluff | Binding | | |
|---|---|---|---|---|---|---|---|
| Sample | | weight | weight | weight | agent weight | Gelation | |
| No. | SAM type | (g) | (g) | (g) | (g) | Time (sec) | Uniformity |
| 1 | Drytech 2035 | 10 | 1000 | 20 | 0 | 39 | Non-uniform |
| 2 | Favor 880 | 10 | 1000 | 20 | 0 | 31 | Non-uniform |
| 3 | Favor 880 | 10 | 1000 | 20 | 0.16 | 34 | Non-uniform |
| 4 | Favor 880 | 10 | 1000 | 20 | 0.32 | 36 | Non-uniform |
| 5 | Favor 880 | 10 | 1000 | 20 | 0.46 | 53 | Uniform |
| 6 | Favor 880 | 10 | 1000 | 20 | 0.79 | 87 | Uniform |
| 7 | Favor 880 | 10 | 1000 | 20 | 1.67 | 204 | Uniform |
| 8 | Polyacrylic | 10 | 1000 | 20 | 0.16 | 375 | Uniform |
| | acid/NaHCO₃ | | | | | | |

### EXAMPLE 3

Samples 9-11 were made to demonstrate the effect of superabsorbent material particle size on the hot air dried absorbent fibrous foams. For making each of Samples 9-11, 1000 grams of distilled water and 30 grams of wood pulp fluff fibers, designated as CR-1654, available from Bowater Corporation, Coosa Pines, Ala., were added into a one gallon HOBART® mixer. The fluff was mixed with the water by the stirrer of the mixer at a relatively slow speed (setting 1). 3 grams of Cellulose Gum CMC-7H, was used as a binding agent and slowly added to the stirring slurry. An additional 1000 grams of water was then added to the mix. After about 15 minutes of stirring, 30 grams of the FAVOR® 880 having a particle size as described in Table 3, was added to the slurry while the stirrer of the mixer is mixing at a relatively fast speed (setting 2). The mixing is continued for about 15 seconds and the slurry was poured into a stainless steel pan with a size of 25.4 centimeters×50.8 centimeters×2.54 centimeters. The pans were then placed into a Baxter oven at 80° C. for 15 hours. The resulting absorbent fibrous foams were then removed from the pans and heated at 130° C. for 2 hours to insolubilize the binding agent. Table 3 summarizes the components and physical characteristics for Samples 9-11, and show.

TABLE 3

| Physical | Favor 880 Particle Size Range | | |
|---|---|---|---|
| Characteristics | 150-300 microns | 300-600 microns | 600-850 microns |
| of Foams | Sample 9 | Sample 10 | Sample 11 |
| Bulk | 0.605 | 1.513 | 1.514 |
| Dimension | | | |
| (cm) | | | |
| Density (g/cm) | 0.068 | 0.041 | 0.036 |
| Softness | 3.95 | 3.70 | 3.63 |
| (gf/gsm) | | | |

### EXAMPLE 4

To further demonstrate the invention several absorbent fibrous foam samples were made and tested according to the Centrifuge Retention Capacity (CRC) Test and the Tensile Strength Test described above. Six hot air dried absorbent foams of this invention, Samples 12-17, were made and tested against six equivalent freeze-dried absorbent fibrous foams, Samples 18-23, for comparison. An additional sample, Sample 24, was made to represent a current commercial absorbent core of a disposable diaper. Sample 24 was made by a conventional airforming method, without a binding agent, such as known in the art. Table 4 summarizes the component amounts used to produce the hot air dried absorbent fibrous foam Samples 12-17, the equivalent freeze-dried absorbent fibrous foam samples 18-23, and Sample 24. Samples 12-24 were made using the superabsorbent material FAVOR® 880 and wood pulp fibers designated as CR-1654, available from Bowater Corporation. The binding agent was a Cellulose Gum CMC-7H.

TABLE 4

| | | SAP | Fluff | Binder | Weight | Thickness | |
|---|---|---|---|---|---|---|---|
| Sample | Drying | added | amount | amount | Percent | of Foam | Density |
| No. | Method | (g) | (g) | (g) | Binder (%) | (mm) | (g/cc) |
| 12 | Hot Air | 37.50 | 37.5 | 0 | 0 | 16.9 | 0.0344 |
| 13 | Hot Air | 36.75 | 36.75 | 1.5 | 2 | 16.9 | 0.0344 |
| 14 | Hot Air | 36.0 | 36.0 | 3.0 | 4 | 14.0 | 0.0415 |
| 15 | Hot Air | 34.50 | 34.5 | 6.0 | 8 | 11.1 | 0.0528 |
| 16 | Hot Air | 33.0 | 33.0 | 9.0 | 12 | 6.9 | 0.0842 |
| 17 | Hot Air | 30.0 | 30.0 | 15.0 | 20 | 4.3 | 0.1352 |
| 18 | Freeze-Drying | 37.50 | 37.50 | 0 | 0 | 22.7 | 0.0262 |
| 19 | Freeze-Drying | 36.75 | 36.75 | 1.5 | 2 | 24.7 | 0.0235 |
| 20 | Freeze-Drying | 36.0 | 36.0 | 3.0 | 4 | 22.5 | 0.0258 |
| 21 | Freeze-Drying | 34.5 | 34.5 | 6.0 | 8 | 20.8 | 0.0279 |
| 22 | Freeze-Drying | 33.0 | 33.0 | 9.0 | 12 | 20.0 | 0.0291 |
| 23 | Freeze-Drying | 30.0 | 30.0 | 15.0 | 20 | 18.0 | 0.0323 |
| 24 | Air-forming | 37.5 | 37.5 | 0 | 0 | 5.8 | 0.1002 |

Each of hot air dried Samples 12-17 was made by the following process. The amount of wood pulp fiber from Table 4 and 1,200 grams of water are placed in a one gallon HOBART® mixer (Model N50, manufactured by Hobart Canada, Ontario, Canada). The fluff was mixed with the water at a slow speed (setting 1 on the mixer). The amount of binding agent from Table 4 was slowly added to the mixer. After stirring for 5 minutes, an additional 1,020 grams of water was added and stirred for an additional 5 minutes. The amount of Favor 880 of Table 4 was added to the slurry while the mixer was stirring at a relatively fast speed (setting 2). The mixer stirred for 10 seconds and the slurry was poured into a 25.4 centimeter×50.8 centimeter×2.54 centimeter stainless steel pan. The pan was placed into a Baxter convection oven at 80° C. for 15 hours. The slurry was heated until all the water was removed. The dried fibrous foam was removed from the pan and heat treated in an oven at 130° C. for 2 hours to insolubilize the binding agent (Sample 12 was also heat treated even though it did not contain the binding agent).

Each freeze dried foam Sample 18-23 was made by the following process. The amount of wood pulp fiber from Table 4 and 1,200 grams of water are placed in a one gallon HOBART® mixer (Model N50, manufactured by Hobart Canada, Ontario, Canada). The fluff was mixed with the water at a slow speed, setting 1 on the mixer. The amount of binding agent from Table 4 was slowly added to the mixer. After stirring for 5 minutes, an additional 1,020 grams of water was added and stirred for an additional 5 minutes. The amount of Favor 880 of Table 4 was added to the slurry while the mixer was stirring at a relatively fast speed (setting 2). The mixer stirred for 10 seconds and the slurry was poured into a 25.4 centimeter×50.8 centimeter×2.54 centimeter stainless steel pan. The pan was placed into a VirTis Genesis freeze dryer (Model 25 EL) available from The VirTis Inc. The slurry was freeze-dried until all the water was removed (approximately 3 to 4 days). The dried fibrous foam was removed from the pan and heat treated in an oven at 130° C. for 2 hours to insolubilize the binding agent (Sample 18 was also heat treated even though it did not contain the binding agent).

Sample 24 was made by placing the amount of wood pulp fiber and superabsorbent material from Table 4 in an airforming handsheet former unit. The airforming handsheet former unit mixed the materials and formed a web of intermingled superabsorbent particles and fibers directly onto a porous sheet of tissue. The tissue was a 9.8 pound White Forming Tissue available from American Tissue Inc. A second layer of tissue was placed above the web following web formation.

Samples 12-24 were tested by the Centrifuge Retention Capacity Test described above to determine the CRC level at various timeframes. The Centrifuge Retention Capacity (CRC) at 0.5 minutes, 1 minute, 2 minutes, 5 minutes, 10 minutes, 20 minutes, and 40 minutes was determined for each of Samples 12-24. By 40 minutes, each of Samples 12-24 had reached the its highest CRC. Table 5 summarizes the results of the CRC at each recorded time and the time, in seconds, to reach 60 percent CRC. The time, in seconds, to reach 60 percent CRC was determined by taking the highest recorded CRC value and multiplying by 0.60 to obtain a value, and determining what time range as shown in Table 5 (0.5 minutes to 1 minute, 1 minute to 2 minutes, etc.) the obtained value is in. The 60 percent CRC value is then obtained using linear interpolation by the following equation:

$$\frac{( A \times 60 \% ) - B}{C - B} \times D + E$$

Where “A” is the highest CRC value of the sample, “B” is the CRC value at the beginning of the time range where the value determined by taking the highest CRC value and multiplying by 0.60 is in, “C” is the CRC value at the end of the time range where the value determined by taking the highest CRC value and multiplying by 0.60 is in, “D” is the change in time over the time range, and “E” is the time from the start (0 seconds) to the time for “B.”

TABLE 5

| | | | | | | | | Time |
|---|---|---|---|---|---|---|---|---|
| | CRC Values (g/g) at Different Time | | | | | | | (sec) to |
| Sample | 0.5 | 1.0 | 2.0 | 5.0 | 10.0 | 20.0 | 40.0 | reach |
| No. | minutes | minute | minutes | minutes | minutes | minutes | minutes | 60% CRC |
| 12 | 6.86 | 10.2 | 12.0 | 13.4 | 14.0 | 14.8 | 15.5 | 51.9 |
| 13 | 5.42 | 8.76 | 10.7 | 11.7 | 12.5 | 12.9 | 13.3 | 53.0 |
| 14 | 5.36 | 9.51 | 11.5 | 12.9 | 13.7 | 14.3 | 14.8 | 55.6 |
| 15 | 5.19 | 9.00 | 11.2 | 12.7 | 13.3 | 14.0 | 14.4 | 57.2 |
| 16 | 4.81 | 8.21 | 10.4 | 11.7 | 12.4 | 13.0 | 13.3 | 58.0 |
| 17 | 4.13 | 6.87 | 8.63 | 9.72 | 10.8 | 11.5 | 11.6 | 61.5 |
| 18 | 9.65 | 12.1 | 13.0 | 14.0 | 14.4 | 14.4 | 14.7 | 27.4 |
| 19 | 9.37 | 11.3 | 12.0 | 12.1 | 12.3 | 12.3 | 12.3 | 23.6 |
| 20 | 9.53 | 11.3 | 12.0 | 12.3 | 12.5 | 12.5 | 12.5 | 23.6 |
| 21 | 9.44 | 11.1 | 11.5 | 11.7 | 11.9 | 11.9 | 11.9 | 22.7 |
| 22 | 9.33 | 10.6 | 11.1 | 11.5 | 11.4 | 11.4 | 11.4 | 22.0 |
| 23 | 8.80 | 10.4 | 11.0 | 11.2 | 11.2 | 11.3 | 11.3 | 23.1 |
| 24 | 5.59 | 8.62 | 11.4 | 12.6 | 13.3 | 13.9 | 14.2 | 59.0 |

As demonstrated in the results of Table 5, hot air dried absorbent fibrous foams of this invention have a slower absorption rate than the equivalent freeze-dried absorbent fibrous foams. Hot air dried absorbent fibrous foams of this invention have a slower absorption rate and reach about 60 percent Centrifuge Retention Capacity, as determined by the Centrifuge Retention Capacity Test described above, in about 30 seconds or more, specifically about 40 seconds or more, and more specifically about 50 seconds or more. The slower absorbing hot air dried absorbent fibrous foams of this invention are useful in absorbent articles when a slower absorption rate is desired. For example, using a slower absorbing absorbent fibrous foam in the insult area of a diaper core, the area directly below the user which receives the first insult, allows the fluid to wick to the areas away from the insult area. The absorbent fibrous foam of the insult area is thus capable of absorbing fluid from subsequent insults.

Samples 12-24 were also tested according to the Tensile Strength Test described above. Before testing, Samples 12-24 were densified to a density of about 0.2 gram/cubic centimeter by a Carver press (Model 4531 Auto Mode), available from Carver Inc. Wabash, Ind. The fibrous foams and air formed composite of Samples 12-24 were then cut to obtain 5.08 centimeters by 12.7 centimeter pieces. Samples 12-24 were tested for both wet and dry tensile strength as described above. The peak load (in grams) for both dry and wet testing was determined and recorded in Table 6. The tensile strength for each sample was determined by dividing the peak load (grams) by the width (centimeters) of the sample multiplied by the basis weight (grams per square meter) of the sample. The tensile strengths of Samples 12-24, recorded in grams/centimeter/grams per square meter (g/cm/gsm), are summarized in Table 6. For samples not able to be broken by the upper force limits of the testing apparatus, the results are recorded as “greater than 3.28 g/cm/gsm” peak load. The binder efficiency of each sample was determined by dividing the tensile strength of each sample by the percent by weight of the binder agent (CMC) in each sample.

TABLE 6

| | | Dry Tensile | | | Wet Tensile | Wet |
|---|---|---|---|---|---|---|
| Sample | Dry Peak | Strength | Dry Binder | Wet Peak | Strength | Binder |
| No. | Load (g) | (g/cm/gsm) | Efficiency | Load (g) | (g/cm/gsm) | Efficiency |
| 12 | 130.0 | 0.0427 | N/A | 21.2 | 0.0070 | N/A |
| 13 | 1138.6 | 0.3736 | 18.68 | 235.2 | 0.0772 | 3.86 |
| 14 | 3158.8 | 1.0364 | 25.91 | 825.4 | 0.2708 | 6.77 |
| 15 | >10,000 | >3.2808 | >41.01 | 2367.8 | 0.7768 | 9.71 |
| 16 | >10,000 | >3.2808 | >27.34 | 6012.3 | 1.9725 | 16.438 |
| 17 | >10,000 | >3.2808 | >16.40 | >10,000 | >3.2808 | >16.40 |
| 18 | 105.2 | 0.0345 | N/A | 25.9 | 0.0085 | N/A |
| 19 | 422.8 | 0.1387 | 6.935 | 64.7 | 0.0212 | 1.06 |
| 20 | 897.4 | 0.2944 | 7.36 | 130.0 | 0.0427 | 1.068 |
| 21 | 1775.8 | 0.5826 | 7.283 | 335.9 | 0.1102 | 1.378 |
| 22 | 5071.1 | 1.6637 | 13.86 | 667.0 | 0.2188 | 1.823 |
| 23 | 8112.5 | 2.6637 | 13.31 | 1298.5 | 0.4260 | 2.13 |
| 24 | 19.1 | 0.0063 | N/A | 75.6 | 0.0248 | N/A |

As demonstrated in the results of Table 6, hot air dried fibrous foams of this invention have high tensile strengths and high binder efficiencies, both while wet and dry. The increased tensile strength due to the hot air drying process allow for reduced amounts of binding agents, thereby lower the overall expense of producing absorbent fibrous foams. All samples not having binding agent, Samples 12, 18, and 24, do not have desired tensile strengths, wet or dry.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

What is claimed is:

1. A wet laid absorbent fibrous foam, comprising:
water insoluble fibers;
a binding agent; and
a superabsorbent material;
wherein the absorbent fibrous foam absorbs about 60 percent of a centrifuge retention capacity of 0.9 percent by weight sodium chloride solution according to the centrifuge retention capacity test, in about 30 seconds or more and has a dry tensile strength of about 0.2 g/cm/gsm or more.

2. The absorbent fibrous foam of claim 1, wherein the absorbent fibrous foam absorbs about 60 percent of the centrifuge retention capacity of 0.9 percent by weight sodium chloride solution according to the centrifuge retention capacity test, in about 40 seconds or more.

3. The absorbent fibrous foam of claim 1, wherein the absorbent fibrous foam has a dry tensile strength of about 0.5 g/cm/gsm or more.

4. The absorbent fibrous foam of claim 1, wherein the absorbent fibrous foam has a wet tensile strength of about 0.05 g/cm/gsm or more.

5. The absorbent fibrous foam of claim 1, comprising about 10 to about 80 weight percent of the superabsorbent material, based on total weight of the absorbent fibrous foam.

6. The absorbent fibrous foam of claim 1, comprising about 40 to about 70 weight percent of the water-insoluble fiber, based on total weight of the absorbent fibrous foam.

7. The absorbent fibrous foam of claim 1, comprising about 0.1 to about 10 weight percent of the binding agent, wherein weight percent is based on total weight of the absorbent fibrous foam.

8. The absorbent fibrous foam of claim 1, wherein the fibrous foam is a densified fibrous foam having a density of about 0.2 to about 0.5 grams foam/cubic centimeter foam.

9. An absorbent article comprising the absorbent fibrous foam of claim 1.

10. A wet laid absorbent fibrous foam, comprising:
water insoluble fibers;
a binding agent; and
a superabsorbent material;
wherein the absorbent fibrous foam absorbs about 60 percent of a centrifuge retention capacity of 0.9 percent by weight sodium chloride solution according to the centrifuge retention capacity test, in about 30 seconds or more and has a dry binder efficiency of about 15 or more.

11. The absorbent fibrous foam of claim 10, wherein the absorbent fibrous foam has a dry binder efficiency of about 20 or more.

12. A wet laid absorbent fibrous foam, comprising:
water insoluble fibers;
a binding agent; and
a superabsorbent material;
wherein the absorbent fibrous foam absorbs about 60 percent of a centrifuge retention capacity of 0.9 percent by weight sodium chloride solution according to the centrifuge retention capacity test, in about 30 seconds or more and has a wet binder efficiency of about 2.5 or more.

13. The absorbent fibrous foam of claim 12, wherein the absorbent fibrous foam has a wet binder efficiency of about 5 or more.

14. A method of producing a wet laid absorbent fibrous foam, comprising:
forming a slurry comprising water, a binding agent, and a water-insoluble fiber;
adding a superabsorbent material having a gelation time of about 40 seconds or more to the slurry;
removing a first amount of the water from the slurry by hot air drying; and
recovering an absorbent fibrous foam.

15. The method of claim 14, wherein the first amount of the water removed by hot air drying is substantially all the water in the slurry.

16. The method of claim 14, wherein the absorbent fibrous foam includes about 10 to about 80 weight percent of the superabsorbent material, based on total weight of the absorbent fibrous foam.

17. The method of claim 14, wherein the absorbent fibrous foam includes about 40 to about 70 weight percent of the water-insoluble fiber, based on total weight of the absorbent fibrous foam.

18. The method of claim 14, wherein the absorbent fibrous foam includes the binding agent in an amount of about 10 weight percent or less, based on total weight of the absorbent fibrous foam.

19. The method of claim 14, wherein the foam absorbs about 60 percent of a centrifuge retention capacity of 0.9 percent by weight sodium chloride solution according to the centrifuge retention capacity test in about 30 seconds or more and has a dry tensile strength of about 0.2 g/cm/gsm or more.

20. The method of claim 19, wherein the foam has a dry tensile strength of about 1.0 g/cm/gsm or more.

21. The method of claim 14, wherein the foam has a wet tensile strength of about 0.05 g/cm/gsm or more.

22. The method of claim 21, wherein the foam has a wet tensile strength of about 0.1 g/cm/gsm or more.

23. The method of claim 14, further comprising adding a crosslinking agent to the slurry and crosslinking the absorbent fibrous foam, wherein the binding agent is water-soluble before adding the superabsorbent material and water-insoluble after recovering the absorbent fibrous foam.

24. The method of claim 14, wherein the hot air drying comprises a temperature of about 60° C. to about 250° C.

25. The method of claim 14, further comprising densifying the absorbent fibrous foam to a density of about 0.2 to about 0.5 grams foam/cubic centimeter foam.

26. The method of claim 14, wherein the superabsorbent material is selected from the group consisting of a nonionic, non-neutralized polymer superabsorbent material, a superabsorbent material including a coating of a nonabsorbent chemical, a non-neutralized ion-exchanging superabsorbent material, and combinations thereof.

27. An absorbent article comprising an absorbent fibrous foam prepared according to the method of claim 14.

28. The method of claim 14, wherein the first amount of water removed from the slurry is less than all of the water in the slurry;
and further comprising freeze-drying the slurry to remove a second amount of water that is substantially all the water remaining in the slurry.

29. The method of claim 28, wherein the first amount of water removed from the slurry by hot air drying is about 10 percent by weight or more of the water.

30. The method of claim 29, wherein the first amount of water removed from the slurry by hot air drying is about 20 percent by weight or more of the water.

31. The method of claim 14, further comprising freeze-drying the slurry before hot air drying the slurry, wherein the freeze-drying removes the first amount of the water from the slurry and the hot air drying removes a second amount of the water from the slurry.

32. The method of claim 31, wherein the first amount of the water is about 10 percent by weight or more of the water and the second amount of the water is about 90 percent by weight or less of the water.

33. The method of claim 32, wherein the first amount of the water is about 20 percent by weight or more of the water and the second amount of the water is about 80 percent by weight or less of the water.
